(19) United States
(12) Patent Application Publication
(10) Pub. No.: US 2003/0168541 A1
(43) Pub. Date: Sep. 11, 2003

(54) Fishing reel

(75) Inventors: Doug Hill, Manchester, NH (US); Mark J. McMenemy, Northborough, MA (US)

Correspondence Address: BOURQUE & ASSOCIATES, P.A., 835 HANOVER STREET, SUITE 303, MANCHESTER, NH, 03104, US

(73) Assignee: Doug Hill

(21) Appl. No.: 10/094,386

(22) Filed: Mar. 8, 2002

(51) Int. Cl. A01K 89/015

(52) U.S. Cl. 242/317

(57) ABSTRACT

A fishing reel drag mechanism includes a manually adjustable dynamic drag mechanism as well as a static drag brake mechanism. The static drag brake mechanism allows a fisherman to select a predetermined amount of static or constant drag whereas the manually adjustable dynamic drag mechanism allows the fisherman to instantly add or lessen the total amount of drag while playing a hooked fish. The manually adjustable dynamic drag mechanism includes a dynamic brake member, a lever, and linkage. The linkage may also include an adjustable leverage mechanism that allows the user to select the desired amount of mechanical advantage. The static drag brake mechanism includes a brake member and a static drag adjuster. The static drag adjuster preferably includes a static drag selection device, a static drag adjustment cam, and an adjustment link pin. The static drag adjustment cam preferably includes a curved channel having a circumferentially decreasing radius. In practice, the fisherman adjusts the amount of static drag by rotating the static drag selection device, thus rotating the static drag adjustment cam and moving the link pin, which in turn moves the brake member.

### TECHNICAL FIELD

The present invention relates to fishing reels and more particularly, to fishing reels having both a static and a manually adjustable line drag.

### BACKGROUND INFORMATION

When a fish takes a hook and starts to run, a very rapid pay out of the line under some resistance is highly desirable. This resistance is commonly referred to as “drag” and its purpose is to prevent the reel from overrunning plus adding resistance to a running fish as well as to tire the fish and enable the fisherman to reel in the fish before it takes off for a subsequent run, the procedure being repeated until the fish is brought in and landed.

It is known to provide a drag mechanism between the spool and its carrier that allows the spool to rotate relatively freely in one direction with respect to the carrier while in the opposite direction of rotation a resistance is imparted to the spool's rotation. Typically, the drag is provided by axially clamping the spool, and there are many known methods of accomplishing this. For example, the spool may be clamped using washers, drums, or disc brake systems.

It is also highly desirable to have a manually adjustable dynamic drag mechanism in addition to the static drag. When fighting large, powerful fish, it is common for the fish to take hundreds of yards of line. A manual levered drag allows a smooth increase in drag against the run, which shortens the run and more quickly tires the fish. In the event the fish jumps or surges, the levered additional drag may be released instantly by releasing the lever, therefore not allowing the line to be broken.

Known fishing reels which have both a manually adjustable static drag brake and a manually engagable brake for selectively adding resistance to the spool typically use a button and suffer from the disadvantage of being difficult to operate. When fishing for multiple types/sizes of fish, the fisherman often needs to be able to quickly add greatly varying amounts of resistance. Unfortunately, the use of a button in the known methods makes the operation difficult because there is no way to easily change the leverage of the button the change to amount of drag a certain amount of drag a given amount of manual hand pressure will generate, to apply significant pressure to the drag mechanism.

Accordingly, what is needed is a fishing reel which has both an adjustable static drag as well as a manually adjustable dynamic drag. Furthermore, what is needed is a fishing reel that is easily operated. The fishing reel should have an adjustable drag to input force ratio allowing the fisherman to apply greatly varying amounts of added resistance.

### SUMMARY

The present invention features a fishing reel drag mechanism having a rotatable spool for storing a fishing line, a frame for supporting the rotatable spool, a manually adjustable dynamic drag mechanism, and a static drag brake mechanism.

The static drag brake mechanism allows a user to select a desired amount of static drag. In one embodiment, the static drag brake member includes a brake member and a static drag adjuster. The brake member is adjustably disposed on the frame and applies the selected amount of static drag against the spool. The brake member may include any known braking system, but preferably includes a rotor and a caliper.

In the preferred embodiment, the static drag adjuster includes a static drag selection device and an adjustment link pin. The static drag selection device allows the user to select the amount of static drag and includes a static drag adjustment cam that is disposed between the static drag selection device and the frame. The static drag adjustment cam preferably includes a channel having a circumferentially decreasing radius.

The adjustment link pin is disposed between the static drag adjustment cam and the brake member. In practice, the user selects the desired amount of static drag by rotating the static drag selection device, thereby rotating the static drag adjustment cam, which in turn moves the adjustment link pin thereby altering the force exerted by the brake member.

The manually adjustable dynamic drag mechanism allows a user to select a desired amount of dynamic drag. In one embodiment, the manually adjustable dynamic drag mechanism includes a dynamic brake member, a lever, an adjustable leverage mechanism, and linkage connecting the lever to the dynamic brake member. The dynamic brake member may include any known braking system, but preferably includes a rotor and a caliper.

The lever is disposed on an external surface of the frame and allows the user to apply the selected amount of dynamic drag against the rotatable spool. The lever facilitates the operation of the dynamic drag mechanism. The dynamic drag mechanism may also include an adjustable leverage mechanism that allows the user to select an amount of mechanical advantage.

### BRIEF DESCRIPTION OF THE DRAWINGS

These and other features and advantages of the present invention will be better understood by reading the following detailed description, taken together with the drawings wherein:

FIG. 1 is an exploded view of one embodiment of the present invention;

FIG. 2 is an enlarged exploded view of the dynamic brake mechanism according to one embodiment;

FIG. 3 is an enlarged exploded view of the static brake mechanism according to one embodiment;

FIG. 4 is a perspective view of the static drag adjuster device according to one embodiment;

FIG. 5 is an exploded perspective view of one embodiment of the static brake mechanism; and

FIG. 6 is a perspective view of the static drag selection device of FIG. 4.

### DETAILED DESCRIPTION OF THE PREFERRED EMBODIMENTS

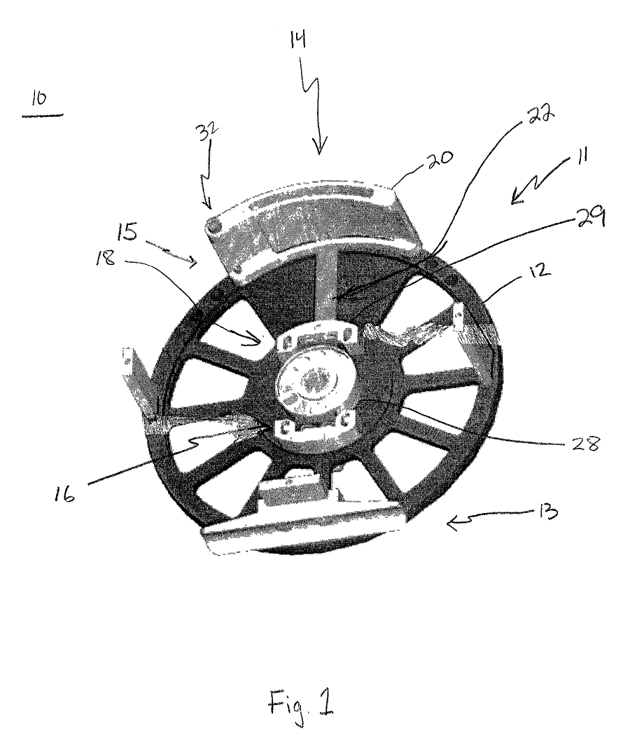

A fishing reel 10, FIG. 1, in accordance with the present invention, includes a fishing reel drag mechanism 11 that allows a spool (not shown) to rotate relatively freely in one direction with respect to the frame 12, while in the opposite direction of rotation a resistance is imparted to the spool's rotation. This resistance is commonly referred to as “drag”; the purpose of which is to prevent any looseness in the fishing line that might allow a fish to jump and snap the line, and to tire the fish and enable the fisherman to reel in the fish before it takes off for a subsequent run.

The fishing reel drag mechanism 11, according to the present invention, includes a manually adjustable dynamic drag mechanism 14 as well as a static drag brake mechanism 16. The static drag brake mechanism 16 allows the fisherman to select a predetermined amount of static or constant drag; whereas the manually adjustable dynamic drag mechanism 14 allows the fisherman to instantly adjust the total amount of drag while playing a hooked fish.

The manually adjustable dynamic drag mechanism 14 includes a dynamic brake member 18, a lever 20, and linkage 22. According to one embodiment of the present invention, the dynamic brake member 18 may include any braking system known to those skilled in the art including, but not limited to, various types of clutches, brake systems (both disc and drum systems), cams, as well as hydraulic systems. In a preferred embodiment, the dynamic brake member 18 includes a brake rotor 28 and a caliper 29. Although the brake rotor 28 appears in connection with frame 12, the brake rotor 28 is typically disposed on and attached to a rotatable spool (not shown) which fits onto, and is supported by, the reel frame 12.

Many of the known dynamic drag mechanisms 14 use a button located near the base 13 of the frame 12 to adjust the amount of dynamic drag. The location of the button, as well as its small surface area, limits access (especially when wearing gloves) and quickly fatigues the fisherman's finger. Consequently, these known dynamic drag mechanisms are difficult and awkward to operate. In addition, existing reels and drag mechanisms (including the use of the palm of a fisherman's hand to apply drag to the rotating spool) expose the user's hand and knuckles to the turning spool rim which might cause injury or a burn.

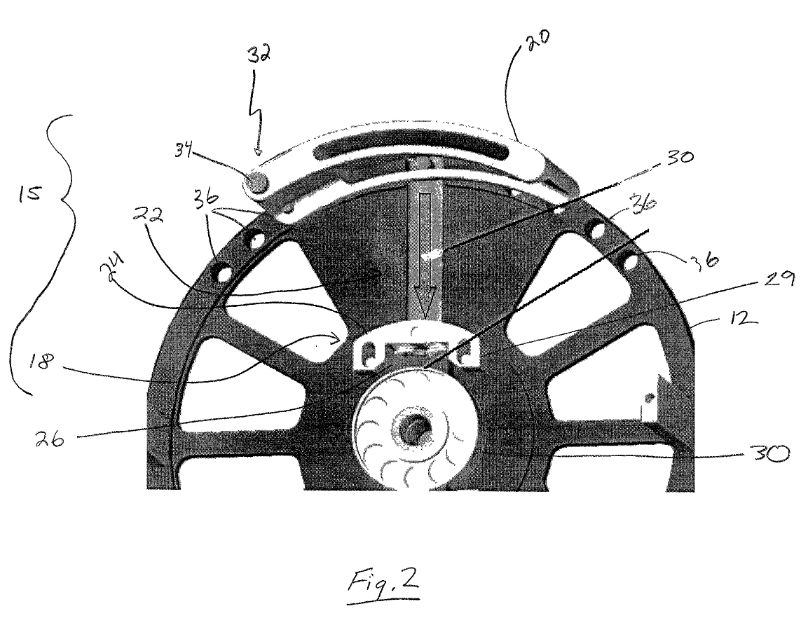

In contrast, according to one embodiment of the present invention, the dynamic drag mechanism 14 preferably includes a lever 20, FIG. 2, located near the top portion 15 of the frame 12, which facilitates the operation of the dynamic drag mechanism 14. The lever 20 preferably has a large surface area that allows the fisherman to easily gain access and apply pressure to the lever 20, even when wearing gloves, and reduces hand fatigue. In practice, the fisherman can easily adjust the amount of dynamic drag by simply pressing on the lever 20 with one or more fingers or the palm of the hand.

The linkage 22 mechanically connects the lever 20 to the dynamic brake member 18. The linkage 22 may include any known method of transferring the force, such as, but not limited to, gears, cams, belts, hydraulics, etc. In a preferred embodiment, the linkage 22 is a rod 30.

According to another embodiment, the lever 20 may also include an adjustable leverage mechanism 32. The adjustable leverage mechanism 32 allows the fisherman to select the desired amount of mechanical advantage, thus permitting the fisherman to customize the fishing reel 10 and the drag mechanism 11 for various types of anticipated fish as well as individual user's strengths. The adjustable leverage mechanism 32 preferably includes a shaft 34 and a plurality of adjustable pivot points 36. To alter the amount of mechanical leverage, the user simply moves the shaft 34 into a different set of adjustable pivot points 36.

The static drag brake mechanism 16, FIG. 3, includes a brake member 38 and a static drag adjuster 40. According to one embodiment of the present invention, the brake member 38 may include any braking system known to those skilled in the art including, but not limited to, various types of clutches, brake systems (both disc and drum systems), cams, as well as hydraulic systems. In a preferred embodiment, the brake member 38 includes a caliper 42 and a brake rotor 28. The brake rotor 28 is preferably the same as the brake rotor 28 used for the manually adjustable dynamic drag mechanism 14.

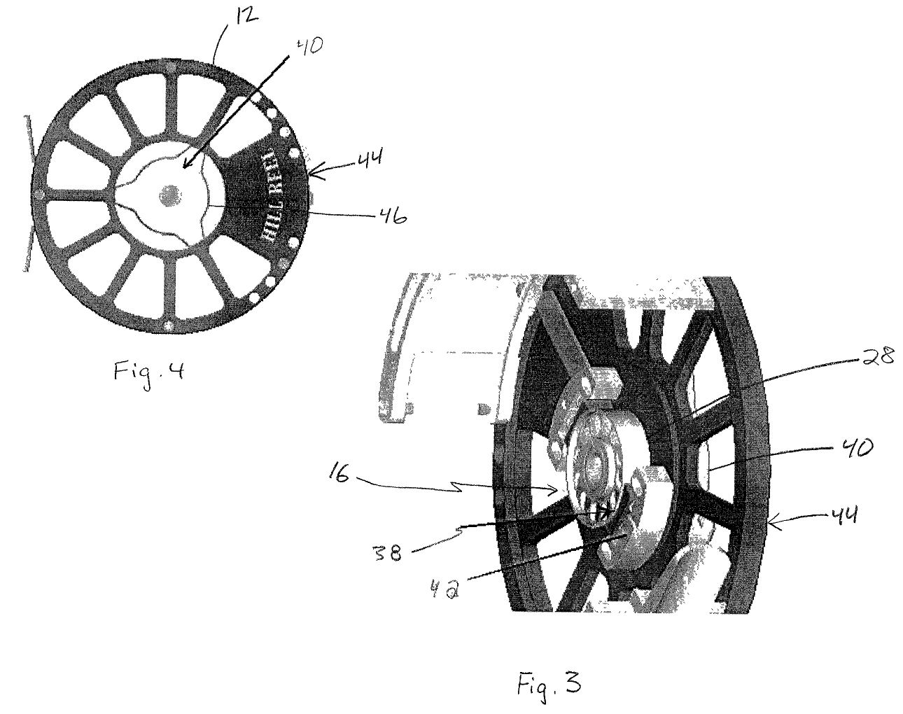

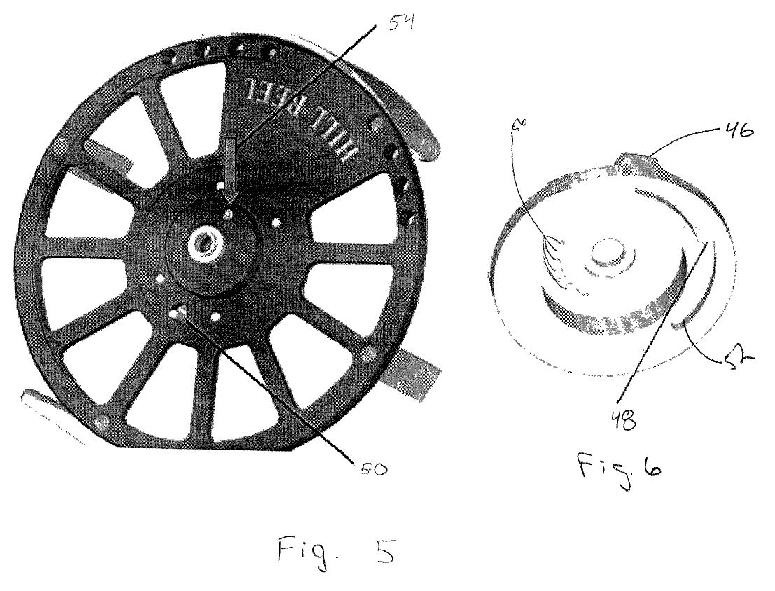

The static drag adjuster 40 is preferably disposed on the outside surface 44, FIG. 4, of the frame 12 and allows the fisherman to select a desired amount of static or constant drag. The static drag adjuster 40 preferably includes a static drag selection device 46, a static drag adjustment cam 48, FIG. 6, and an adjustment link pin 50. The link pin 50 is disposed between the static drag adjustment cam 48 and the brake member 38.

The static drag adjustment cam 48, FIG. 6, may include any cam design known to those skilled in the art, but preferably includes a curved channel 52 having a circumferentially decreasing radius. In practice, the fisherman adjusts the amount of static drag by rotating the static drag selection device 46, thus rotating the static drag adjustment cam 48 and moving the link pin 50, which in turn urges the brake caliber 42 against the brake rotor 28, thus applying more “drag”.

The static drag brake mechanism 16 may also include a detent plunger 54 that serves to indicate, using an audible “click” sound, the current amount and adjustment of static drag. The detent plunger 54 ratchets in the plurality of indicator holes 56 that are disposed on the static drag selection device 46 thus causing the “clicking” sound.

Modifications and substitutions by one of ordinary skill in the art are considered to be within the scope of the present invention, which is not to be limited except by the following claims.

The invention claimed is:

1. A fishing reel drag mechanism comprising:
a frame;
a manually adjustable dynamic drag mechanism; and
a static drag brake mechanism comprising:
a brake member adjustably disposed on said frame; and
a static drag adjuster comprising:
a static drag selection device, disposed on an outside surface of said frame, and coupled to a static drag adjustment cam; and
an adjustment link pin disposed between said static drag adjustment cam and said brake member, wherein said user selects said user selected amount of static drag by rotating said static drag selection device, thereby rotating said static drag adjustment cam, which in turn moves said adjustment link pin thereby altering said force exerted by said brake member.

2. The fishing reel drag mechanism as claimed in claim 1 wherein said brake member includes a caliper and a brake rotor, and wherein said brake rotor is disposed coaxially on a rotatable spool supported by said frame.

3. The fishing reel drag mechanism as claimed in claim 1 wherein said static drag adjustment cam comprises a curved channel having a circumferencially decreasing radius.

4. The fishing reel drag mechanism as claimed in claim 1 wherein said a manually adjustable dynamic drag mechanism comprises:
a dynamic drag brake member;
a lever, disposed on an external surface of said frame; and
linkage connecting said lever to said dynamic brake member.

5. The fishing reel drag mechanism as claimed in claim 4 wherein said dynamic brake member includes a caliper and a brake rotor, wherein said brake rotor is disposed coaxially on a rotatable spool supported by said frame.

6. The fishing reel drag mechanism as claimed in claim 5, wherein said manually adjustable dynamic drag mechanism further comprises an adjustable leverage mechanism.

7. The fishing reel drag mechanism as claimed in claim 6, wherein said adjustable leverage mechanism includes a plurality of adjustable pivot points disposed proximate an end of said lever.

8. A fishing reel drag mechanism comprising:
a frame;
a static drag brake mechanism; and
a manually adjustable dynamic drag mechanism comprising:
a dynamic brake member;
a lever disposed on an external surface of said frame;
an adjustable leverage mechanism; and
linkage connecting said lever to said dynamic brake member.

9. The fishing reel drag mechanism as claimed in claim 8 wherein said dynamic brake member includes a caliper and a brake rotor, wherein said brake rotor is disposed coaxially on a rotatable spool supported by said frame.

10. The fishing reel drag mechanism as claimed in claim 8, wherein said static drag brake mechanism comprises a separate brake member adjustably disposed on said frame.

11. The fishing reel drag mechanism as claimed in claim 10 wherein said brake member includes a caliper and a brake rotor.

12. The fishing reel drag mechanism as claimed in claim 8, wherein said static drag brake mechanism further comprises:
a static drag selection device, coupled to a static drag adjustment cam; and
an adjustment link pin disposed between said static drag adjustment cam and said brake member, wherein said user selects said user selected amount of static drag by rotating said static drag selection device, thereby rotating said static drag adjustment cam, which in turn moves said adjustment link pin thereby altering said force exerted by said brake member against a rotatable spool supported by said frame.

13. The fishing reel drag mechanism as claimed in claim 12 wherein said brake member includes a caliper and a brake rotor, wherein said brake rotor is disposed coaxially on said rotatable spool.

14. The fishing reel drag mechanism as claimed in claim 13 wherein said static drag adjustment cam comprises a curved channel having a circumferencially decreasing radius.

15. The fishing reel drag mechanism as claimed in claim 13 wherein said adjustable leverage mechanism includes a plurality of adjustable pivot points disposed proximate an end of said lever.

16. A fishing reel drag mechanism comprising:
a frame for supporting a rotatable spool;
a manually adjustable dynamic drag mechanism comprising:
a dynamic brake member;
a lever disposed on an external surface of said frame;
an adjustable leverage mechanism; and
linkage connecting said lever to said dynamic brake member; and
a static drag brake mechanism comprising:
a static drag brake member adjustably disposed on said frame; and
a static drag adjuster comprising:
a static drag selection device coupled to a static drag adjustment cam; and
an adjustment link pin disposed between said static drag adjustment cam and said static drag brake member, wherein said user selects said user selected amount of static drag by rotating said static drag selection device, thereby rotating said static drag adjustment cam, which in turn moves said adjustment link pin thereby altering said force exerted by said static drag brake.

17. The fishing reel drag mechanism as claimed in claim 16 wherein said dynamic brake member includes a caliper and a brake rotor, wherein said brake rotor is disposed coaxially on said rotatable spool.

18. The fishing reel drag mechanism as claimed in claim 16 wherein said brake member includes a caliper and a brake rotor, wherein said brake rotor is disposed coaxially on said rotatable spool.

19. The fishing reel drag mechanism as claimed in claim 16 wherein said fishing reel drag mechanism further includes a brake rotor disposed coaxially on said rotatable spool, and wherein said dynamic brake member and said brake member include a caliper.

20. A fishing reel drag mechanism comprising:
a rotatable spool, for storing a fishing line;
a frame for supporting said rotatable;
a manually adjustable dynamic drag mechanism comprising:
a dynamic brake member;
a lever disposed on an external surface of said frame;
an adjustable leverage mechanism; and
linkage connecting said lever to said dynamic brake member; and
a static drag brake mechanism comprising:
a static drag brake member adjustably disposed on said frame; and
a static drag adjuster comprising:
a static drag selection device, disposed on an outside surface of said frame, having a static drag adjustment cam disposed between said static drag selection device and said frame; and
an adjustment link pin disposed between said static drag adjustment cam and said static drag brake member, wherein said user selects said user selected amount of static drag by rotating said static drag selection device, thereby rotating said static drag adjustment cam, which in turn moves said adjustment link pin thereby altering said force exerted by said static drag brake.

21. A fishing reel drag mechanism comprising:
a rotatable spool, for storing a fishing line;
a frame for supporting said rotatable spool;
a manually adjustable dynamic drag mechanism, for applying a user selectable amount of dynamic drag against said rotatable spool; and
a static drag brake mechanism, for setting a user selectable amount of static drag, said static drag brake mechanism comprising:
a brake member, adjustably disposed on said frame, for applying said user selected amount of static drag against said rotatable spool; and
a static drag adjuster comprising:
a static drag selection device, for selecting said user selected amount of static drag, said static drag selection device coupled to a static drag adjustment cam; and
an adjustment link pin, disposed between said static drag adjustment cam and said brake member, for applying said user selected amount of static drag against said brake member, wherein said user selects said user selected amount of static drag by rotating said static drag selection device, thereby rotating said static drag adjustment cam, which in turn moves said adjustment link pin thereby altering said force exerted by said brake member.

22. The fishing reel drag mechanism as claimed in claim 21 wherein said brake member includes a caliper and a brake rotor, wherein said brake rotor is disposed coaxially on said rotatable spool.

23. The fishing reel drag mechanism as claimed in claim 21 wherein said static drag adjustment cam comprises a curved channel having a circumferencially decreasing radius.

24. The fishing reel drag mechanism as claimed in claim 21 wherein said a manually adjustable dynamic drag mechanism comprises:
a dynamic drag brake member, for applying said user selected amount of dynamic drag against said rotatable spool;
a lever, disposed on an external surface of said frame, for applying said user selected amount of dynamic drag against said rotatable spool; and
linkage connecting said lever to said dynamic brake member, for transmitting said user selected amount of dynamic drag from said lever to said dynamic brake member.

25. The fishing reel drag mechanism as claimed in claim 24 wherein said dynamic brake member includes a caliper and a brake rotor, wherein said brake rotor is disposed coaxially on said rotatable spool.

26. The fishing reel drag mechanism as claimed in claim 25, wherein said manually adjustable dynamic drag mechanism further comprises an adjustable leverage mechanism, for allowing said user to select an amount of mechanical advantage for said manually adjustable dynamic drag mechanism.

27. The fishing reel drag mechanism as claimed in claim 26, wherein said adjustable leverage mechanism includes a plurality of adjustable pivot points disposed proximate an end of said lever.

28. A fishing reel drag mechanism comprising:
a rotatable spool, for storing a fishing line;
a frame for supporting said rotatable spool;
a static drag brake mechanism, for setting a user selectable amount of static drag; and
a manually adjustable dynamic drag mechanism, for applying a user selectable amount of dynamic drag against said rotatable spool, said manually adjustable dynamic drag mechanism comprising:
a dynamic brake member, for applying said user selected amount of dynamic drag against said rotatable spool;
a lever, disposed on an external surface of said frame, for applying said user selected amount of dynamic drag against said rotatable spool;
an adjustable leverage mechanism, for allowing said user to select an amount of mechanical advantage; and
linkage connecting said lever to said dynamic brake member, for transmitting said user selected amount of dynamic drag from said lever to said rotatable spool.

29. The fishing reel drag mechanism as claimed in claim 28 wherein said dynamic brake member includes a caliper and a brake rotor, wherein said brake rotor is disposed coaxially on said rotatable spool.

30. The fishing reel drag mechanism as claimed in claim 28, wherein said static drag brake mechanism comprises a separate brake member, adjustably disposed on said frame, for applying said user selected amount of static drag against said brake rotor.

31. The fishing reel drag mechanism as claimed in claim 30 wherein said brake member includes a caliper and a brake rotor.

32. The fishing reel drag mechanism as claimed in claim 28, wherein said static drag brake mechanism further comprises:
a static drag selection device, disposed on an outside surface of said frame, for selecting said user selected amount of static drag, said static drag selection device having a static drag adjustment cam disposed between said static drag selection device and said spool; and
an adjustment link pin, disposed between said static drag adjustment cam and said brake member, for applying said user selected amount of static drag against said brake member, wherein said user selects said user selected amount of static drag by rotating said static drag selection device, thereby rotating said static drag adjustment cam, which in turn moves said adjustment link pin thereby altering said force exerted by said brake member against said spool.

33. The fishing reel drag mechanism as claimed in claim 32 wherein said brake member includes a caliper and a brake rotor, wherein said brake rotor is disposed coaxially on said rotatable spool.

34. The fishing reel drag mechanism as claimed in claim 33 wherein said static drag adjustment cam comprises a curved channel having a circumferencially decreasing radius.

35. The fishing reel drag mechanism as claimed in claim 33 wherein said adjustable leverage mechanism includes a plurality of adjustable pivot points disposed proximate an end of said lever.

36. A fishing reel drag mechanism comprising:
a rotatable spool, for storing a fishing line;
a frame for supporting said rotatable;
a manually adjustable dynamic drag mechanism, for applying a user selectable amount of dynamic drag against said rotatable spool, said manually adjustable dynamic drag mechanism comprising:
a dynamic brake member, for applying said user selected amount of dynamic drag against said rotatable spool;
a lever, disposed on an external surface of said frame, for applying said user selected amount of dynamic drag against said rotatable spool;
an adjustable leverage mechanism, for allowing said user to select an amount of mechanical advantage; and
linkage connecting said lever to said dynamic brake member for transmitting said user selected amount of dynamic drag from said lever to said dynamic brake member; and
a static drag brake mechanism, for setting a user selectable amount of static drag, said static drag brake mechanism comprising:
a static drag brake member, adjustably disposed on said frame, for applying said user selected amount of static drag against said rotatable spool; and
a static drag adjuster comprising:
a static drag selection device, disposed on an outside surface of said frame, for manually selecting said user selected amount of static drag, said static drag selection device having a static drag adjustment cam disposed between said static drag selection device and said frame; and
an adjustment link pin, disposed between said static drag adjustment cam and said static drag brake member, for applying said user selected amount of static drag against said static drag brake member, wherein said user selects said user selected amount of static drag by rotating said static drag selection device, thereby rotating said static drag adjustment cam, which in turn moves said adjustment link pin thereby altering said force exerted by said static drag brake.

37. The fishing reel drag mechanism as claimed in claim 36 wherein said dynamic brake member includes a caliper and a brake rotor, wherein said brake rotor is disposed coaxially on said rotatable spool.

38. The fishing reel drag mechanism as claimed in claim 36 wherein said brake member includes a caliper and a brake rotor, wherein said brake rotor is disposed coaxially on said rotatable spool.

39. The fishing reel drag mechanism as claimed in claim 36 wherein said fishing reel drag mechanism further includes a brake rotor disposed coaxially on said rotatable spool, and wherein said dynamic brake member and said brake member include a caliper.
